(19) United States
(12) Patent Application Publication
(10) Pub. No.: US 2012/0013686 A1
(43) Pub. Date: Jan. 19, 2012

(54) LIQUID-JET HEAD AND LIQUID-JET APPARATUS HAVING SAME

(75) Inventor: Junhua ZHANG, Shiojiri-shi (JP)

(73) Assignee: SEIKO EPSON CORPORATION, Tokyo (JP)

(21) Appl. No.: 13/244,314

(22) Filed: Sep. 24, 2011

Related U.S. Application Data
(63) Continuation of application No. 12/013,061, filed on Jan. 11, 2008.

(30) Foreign Application Priority Data
Jan. 12, 2007 (JP) 2007-005030
Dec. 17, 2007 (JP) 2007-325193
Jan. 8, 2008 (JP) 2008-001268

(51) Int. Cl. B41J 2/045

(52) U.S. Cl. 347/68

(57) ABSTRACT

A liquid-jet head comprising a pressure generating chamber, which is supplied with a liquid via a liquid supply path and in which a nozzle orifice for jetting the liquid is formed, and a pressure generator for causing a pressure change within the pressure generating chamber, wherein when an inertance and a passage resistance of the liquid supply path are designated as M₁ and R₁, respectively, and an inertance and a passage resistance of the nozzle orifice are designated as M₂ and R₂, respectively, relationships M₂<M₁ and R₂>2×R₁ hold.

### CROSS REFERENCE TO RELATED APPLICATIONS

This application is a Continuation application of U.S. patent application Ser. No. 12/013,061 filed Jan. 11, 2008, which claims priority from Japanese Patent Application Nos. 2007-005030 filed Jan. 12, 2007, 2007-325193 filed Dec. 17, 2007 and 2008-001268 filed Jan. 8, 2008; the entire disclosures of the prior applications are expressly incorporated by reference herein.

### BACKGROUND

1. Technical Field

The present invention relates to a liquid-jet head and a liquid-jet apparatus having the liquid-jet head, which are useful particularly when applied in using a highly viscous liquid.

2. Related Art

An example of a liquid-jet apparatus is an ink-jet recording apparatus including an ink-jet recording head equipped with a plurality of pressure generating chambers for generating pressure for ink droplet ejection by a pressure generator comprising a piezoelectric element, an ink supply path for supplying ink individually to each pressure generating chamber from a common reservoir, and a nozzle orifice formed in each pressure generating chamber for ejecting ink droplets. In this ink-jet recording apparatus, ejection energy is imparted to the ink within the pressure generating chamber communicating with a nozzle corresponding to a print signal to eject ink droplets through the nozzle orifice.

Objects, on which predetermined letters and graphics are printed by this type of ink-jet recording apparatus, have recently ranged widely, including plastics, glass, etc. as well as paper hitherto used. Conventional ink targeted at paper, etc., however, is not fully effective for objects of printing having a low ink absorption, such as plastics. That is, if ink targeted for paper is printed, for example, on a plastic, the viscosity of the paper-targeted ink (a viscosity, for example, of the order of 3.5 (mPa·s) at ordinary temperature) is too low to be printed on the plastic, presenting the problem that an ink droplet flows after landing on the object of printing.

Thus, when printing is done on an object of printing with a low ink absorption, such as a plastic, ink having a high viscosity (for example, of the order of 10.0 (mPa·s) at ordinary temperature) has been used. Conventionally, however, the high viscosity ink has merely been used, and the structure of the ink-jet recording head itself has not been changed. That is, there has been adopted a structure in which the inertances and passage resistances of the ink supply path and the nozzle orifice, as physical quantities affecting the ejection characteristics of ink in this type of ink-jet recording head, have comparable values; namely, the inertance of the ink supply path is comparable in value to that of the nozzle orifice, and the passage resistance of the ink supply path is comparable in value to that of the nozzle orifice.

The following document can be named as an example of related art which discusses inertance and passage resistance as mentioned above:
JP-A-2006-290000 (FIG. 1, paragraphs [0022] to [0027])

When printing is performed using high viscosity ink by the ink-jet recording head according to the related art, however, the following problems have occurred: The amount of the ink droplet ejected through the nozzle orifice is so small that printing quality is adversely affected. Besides, meniscus after ejection exhibits such a behavior as to return slowly, thus prolonging the ejection cycle of the ink. This has been an impediment to high speed printing.

FIGS. 24A and 24B are characteristic charts simulating meniscus behaviors exhibited when predetermined ink was ejected with the use of the ink-jet recording head according to the related art. FIG. 24A shows the characteristics when the viscosity of the ink was 5.0 (mPa·s), and FIG. 24B shows the characteristics when the viscosity of the ink was 10.0 (mPa·s). In these drawings, the abscissa represents time (μs), and the ordinate represents the weight of the ink ejected (ng). The viscosity of the ink was the viscosity at the temperature of the ink during ejection.

Other parameters of the ink-jet recording head were as follows:

The diameter of the nozzle orifice was 24 μm. The inertance of the ink supply path, M₁, was 1.5×10⁸ (kg/m⁴). The inertance of the nozzle orifice, M₂, was 1.4×10⁸ (kg/m⁴). The passage resistance of the ink supply path, R₁, was 2.0×10¹³ (Pa·s/m³). The passage resistance of the nozzle orifice, R₂, was 2.1×10¹³ (Pa·s/m³).

The inertances M₁ and M₂, and the passage resistances R₁ and R₂ were all the values obtained when the viscosity of the ink was 5.0 (mPa·s).

Reference to FIGS. 24A, 24B shows that when the viscosity of the ink was 5.0 (mPa·s), 12 (ng) of an ink droplet was ejected, and return after ejection was sufficiently fast, as shown in FIG. 24A. When the viscosity of the ink was 10.0 (mPa·s), on the other hand, only 10 (ng) of an ink droplet was ejected, and return after ejection was very slow, as shown in FIG. 24B.

Such problems exist not only with an ink-jet recording head which ejects ink, but also with a liquid-jet head which jets a liquid other than ink. Liquid-jet heads for use in industrial applications other than printing, in particular, have many opportunities to jet a highly viscous liquid, and have the above problems becoming manifest.

### SUMMARY

An advantage of some aspects of the invention is to provide a liquid-jet head, which can ensure an adequate amount of ejection even when using a highly viscous liquid, and can impart a satisfactory meniscus behavior after ejection to contribute to high speed printing, and a liquid-jet apparatus having the liquid-jet head.

According to an aspect of the invention, there is provided a liquid-jet head comprising a pressure generating chamber, which is supplied with a liquid via a liquid supply path and in which a nozzle orifice for jetting the liquid is formed, and a pressure generator for causing a pressure change within the pressure generating chamber, wherein when an inertance and a passage resistance of the liquid supply path are designated as M₁ and R₁, respectively, and an inertance and a passage resistance of the nozzle orifice are designated as M₂ and R₂, respectively, relationships M₂<M₁ and R₂>2×R₁ hold.

According to this aspect, the structures of the liquid supply path and the nozzle orifice are determined, with the passage resistances of the liquid supply path and the nozzle orifice being set in appropriate relationship, in addition to the well known finding that the ejection characteristics of a liquid vary with the ratio between the inertance of the liquid supply path and the inertance of the nozzle orifice. Thus, even when a highly viscous liquid is used, an adequate amount of ejection of the liquid can be ensured, and satisfactory return of meniscus after ejection can be obtained. As a result, the printing quality of printing products obtained by use of the high viscosity liquid can be kept satisfactory, and a contribution to high speed printing can be made.

The liquid-jet head becomes even more preferred, if it uses the liquid whose viscosity is 8.0 (mPa·s) or higher. In this case, desired satisfactory printing can be done even on plastics having a smooth surface and having no absorbency. Particularly, it is preferred for the liquid to have a viscosity of 8.0 (mPa·s) or higher, but 20.0 (mPa·s) or lower. In this case, an adequate amount of ejection of the liquid can be ensured, and satisfactory return of meniscus after ejection can be achieved. Moreover, the relationship between the passage resistances R₁ and R₂ is desired to be 3×R₁≦R₂≦20×R₁. By so doing, an adequate amount of ejection of the liquid can be ensured, and satisfactory return of meniscus after ejection can be achieved.

Furthermore, the liquid-jet head is preferably configured such that when the cross-sectional area of the liquid supply path is designated as S₁, and the cross-sectional area of the liquid ejection port of the nozzle orifice is designated as S₂, the relationship S₂<S₁ holds. In this case, the aforementioned inertances M₁ and M₂ and the passage resistances R₁ and R₂ can be easily brought into the predetermined relationships as described above.

According to another aspect of the invention, there is provided a liquid-jet apparatus including each of the liquid-jet heads described above.

According to this aspect, the liquid-jet apparatus is particularly useful as a printing apparatus for performing desired printing on plastics having a smooth surface and lacking absorbency.

### BRIEF DESCRIPTION OF THE DRAWINGS

The invention will be described with reference to the accompanying drawings, wherein like numbers reference like elements.

FIGS. 1A and 1B are sectional views of a recording head according to an embodiment of the invention.

FIGS. 2A and 2B are explanation drawings showing the dimensions of respective portions of the recording head shown in FIGS. 1A and 1B.

FIGS. 3A and 3B are explanation drawings showing methods for obtaining inertance and passage resistance.

FIG. 4 is a perspective view of a piezoelectric element unit in FIGS. 1A and 1B.

FIGS. 5A and 5B are a plan view and a sectional view, respectively, of the piezoelectric element unit in FIGS. 1A and 1B.

FIG. 6 is a graph showing the ink ejection characteristics of the recording head according to the embodiment.

FIG. 7 is a graph showing the ink ejection characteristics of the recording head according to other embodiment.

FIG. 8 is a graph showing the ink ejection characteristics of the recording head according to the other embodiment.

FIG. 9 is a graph showing the ink ejection characteristics of the recording head according to the other embodiment.

FIG. 10 is a graph showing the ink ejection characteristics of the recording head according to the other embodiment.

FIG. 11 is a graph showing the ink ejection characteristics of the recording head according to the other embodiment.

FIG. 12 is a waveform chart showing an example of a drive waveform.

FIG. 13 is a waveform chart showing another example of a drive waveform.

FIG. 14 is a graph showing the ink ejection characteristics of the recording head according to the other embodiment.

FIG. 15 is a graph showing the ink ejection characteristics of the recording head according to the other embodiment.

FIG. 16 is a graph showing the ink ejection characteristics of the recording head according to the other embodiment.

FIG. 17 is a graph showing the ink ejection characteristics of the recording head according to the other embodiment.

FIG. 18 is a graph showing the ink ejection characteristics of the recording head according to the other embodiment.

FIG. 19 is a graph showing the ink ejection characteristics of the recording head according to the other embodiment.

FIG. 20 is a graph showing the ink ejection characteristics of the recording head according to the other embodiment.

FIG. 21 is a graph showing the ink ejection characteristics of the recording head according to the other embodiment.

FIG. 22 is a graph showing the ink ejection characteristics of the recording head according to the other embodiment.

FIG. 23 is a schematic view showing a recording apparatus loaded with the recording head shown in FIGS. 1A and 1B.

FIGS. 24A and 24B are graphs showing the ink ejection characteristics of a recording head according to the related art.

### DESCRIPTION OF EXEMPLARY EMBODIMENTS

Embodiments of the invention will now be described in detail with reference to the accompanying drawings.

### First Embodiment

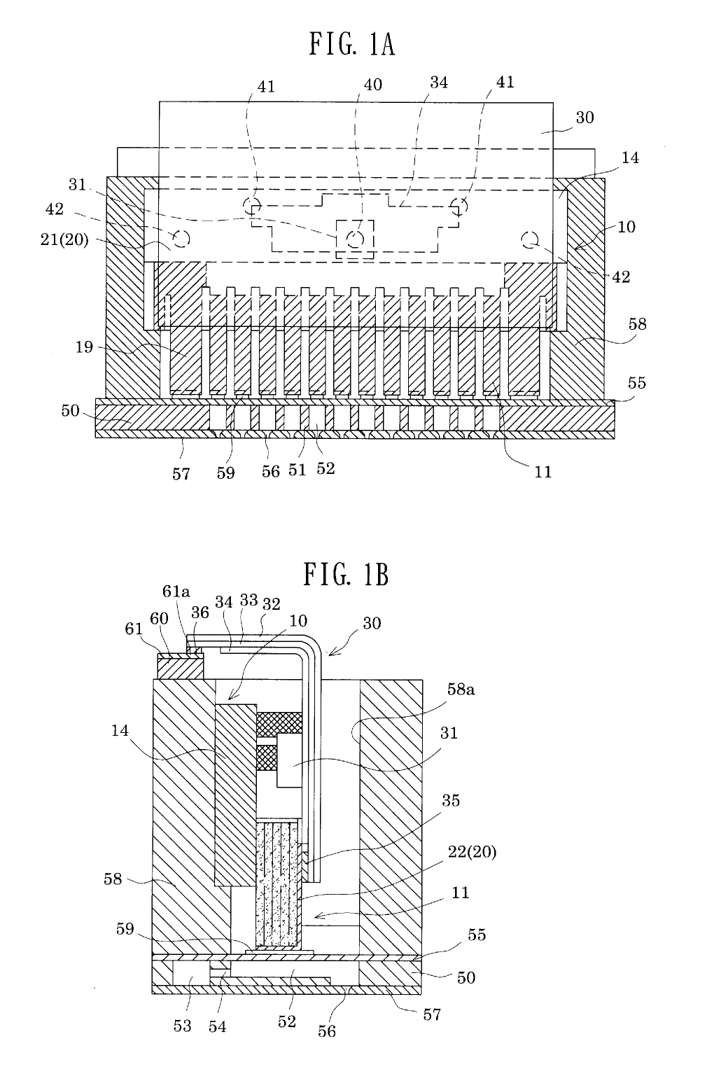

FIG. 1A is a sectional view, in a transverse direction (a direction perpendicular to a longitudinal direction), of a pressure generating chamber of an ink-jet recording head which is an example of a liquid-jet head according to an embodiment of the invention. FIG. 1B is a sectional view, in the longitudinal direction, of the pressure generating chamber of the ink-jet recording head which is an example of the liquid-jet head. As shown in these drawings, a passage-forming substrate 50 consists of a single crystal silicon substrate. In a surface layer portion on one side of the passage-forming substrate 50, pressure generating chambers 52 defined by a plurality of compartment walls 51 are arranged parallel in the width direction (transverse direction) of the passage-forming substrate 50. A reservoir 53 for supplying ink, a type of a liquid, to each pressure generating chamber 52 is in communication with one end portion, in the longitudinal direction, of each pressure generating chamber 52 via an ink supply path 54 which is a type of a liquid supply path. A side of the passage-forming substrate 50, where the pressure generating chambers 52 have an opening surface, is sealed with a vibration plate 55. To the other side of the passage-forming substrate 50, a nozzle plate 57 having nozzle orifices 56 bored therein is secured via an adhesive agent or a heat sealing film.

A head case 58 having ink supply paths connected to a plurality of ink cartridges (not shown) is fixed onto the vibration plate 55, and a piezoelectric element unit 10 is fixed to the head case 58 while being positioned with high accuracy. That is, the head case 58 has a penetrated accommodating portion 58a provided therein. The piezoelectric element unit 10 is fixed to one of the inner surfaces of the accommodating portion 58a such that the leading end of each piezoelectric element 11 is in contact with each island portion 59 provided on the vibration plate 55 in a region corresponding to each pressure generating chamber 52.

With such an ink-jet recording head, a pressure change is caused to the pressure generating chamber 52 via the vibration plate 55 by the displacement of the piezoelectric element 11 associated with the supply of a drive signal. Upon this pressure change, ink filled within the pressure generating chamber 52 is ejected through the nozzle orifice 56. Here, the ink is supplied from the reservoir 53 to each pressure generating chamber 52 via each ink supply path 54. The ejection characteristics of the ink on this occasion are defined by the inertances and passage resistances of the ink supply path 54 and the nozzle orifice 56.

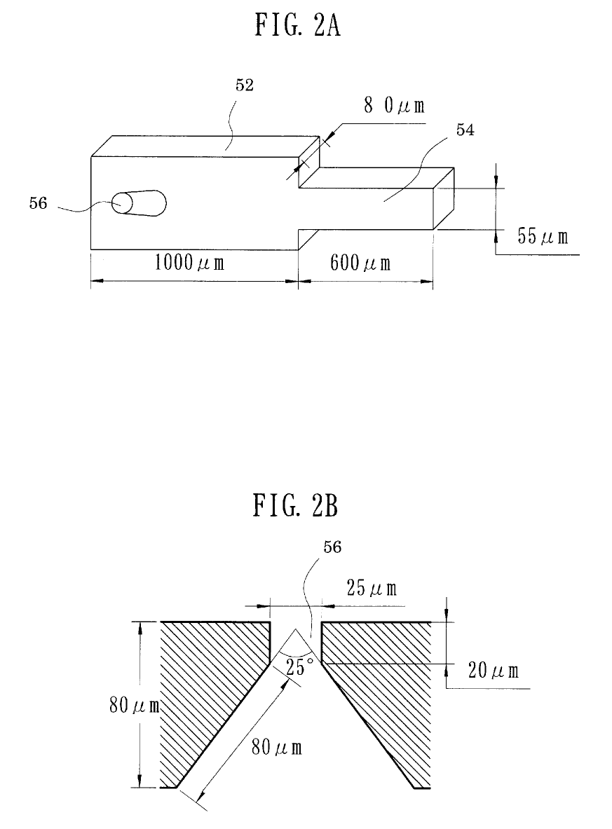

In the present embodiment, the inertances of the ink supply path 54 and the nozzle orifice 56 are designated as M₁ and M₂, respectively, and the passage resistances of the ink supply path 54 and the nozzle orifice 56 are designated as R₁ and R₂, respectively. In this case, the relationships M₂<M₁ and R₂>2R₁ hold. The viscosity of the ink used is 8.0 (mPa·s) or higher, and more preferably, it is as high as 10.0 (mPa·s) or higher. The dimensions of the ink supply path 54 and the nozzle orifice 56, etc. are as shown in FIGS. 2A and 2B. FIG. 2A is a schematic view showing the ink supply path 54, the pressure generating chamber 52, and the nozzle orifice 56 in an extracted manner. FIG. 2B is a sectional view showing the nozzle orifice 56 in an enlarged manner. As shown in FIG. 2A, the ink supply path 54 is 600 μm long, 55 μm in width, and 80 μm in height. The length of the pressure generating chamber 52 is 1,000 μm. As shown in FIG. 2B, the nozzle has an 80 μm portion (taper portion) having a diameter gradually decreasing toward the leading end, and the nozzle orifice 56 of a cylindrical shape is formed to be continuous with the leading end of the taper portion. The diameter of the nozzle orifice 56 is 25 μm. The height of the nozzle orifice 56 is 20 μm, and the thickness of the nozzle portion, which includes both of the cylindrical portion and the taper portion, is 80 μm.

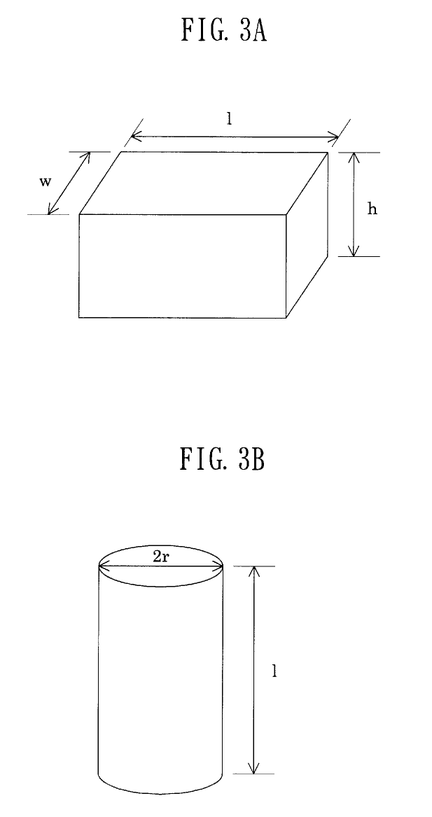

The typical ways of determining the inertance and the passage resistance are explained below. If the passage is a hollow rectangular parallelepipedal (or cuboidal) body as shown in FIG. 3A, its inertance M_{cuboidal}=(ρl/wh), and its passage resistance R_{cuboidal}=(12 μl/wh³). Alternatively, if the passage is a cylindrical body as shown in FIG. 3B, its inertance M_{cylindrical}=(ρl/πr²), and its passage resistance R_{cylindrical}=(8 μl/πr⁴). In these equations, μ is the viscosity of the ink, and ρ is the density of the ink.

If the shape of the ink supply path 54 can be approximated by a hollow cuboidal body, the inertance M₁ and passage resistance R₁ of the ink supply path 54 can be obtained by making use of the above equations for determining the inertance M_{cuboidal} and the passage resistance R_{cuboidal}. If the shape of the nozzle orifice 56 can be approximated by a cylindrical body, on the other hand, the inertance M₂ and passage resistance R₂ of the nozzle orifice 56 can be obtained by making use of the above equations for determining the inertance M_{cylindrical} and the passage resistance R_{cylindrical}. Even if such approximations are impossible, the desired inertances M₁, M₂ and passage resistances R₁, R₂ can be obtained by similar calculations with the use of integration.

The above-mentioned predetermined relationships can be easily established by configuring the recording head such that when the cross-sectional area of the passage of the ink supply path 54 is designated as S₁ and the cross-sectional area of the passage of the ink ejection port of the nozzle orifice 56 is designated as S₂, the relationship S₂<S₁ holds.

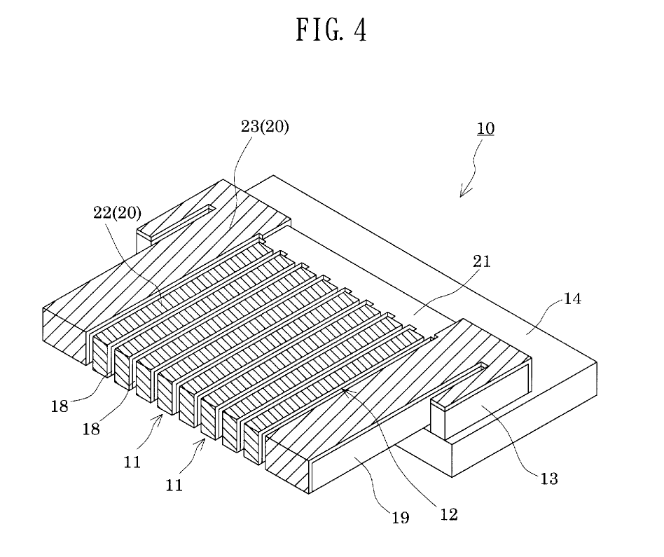

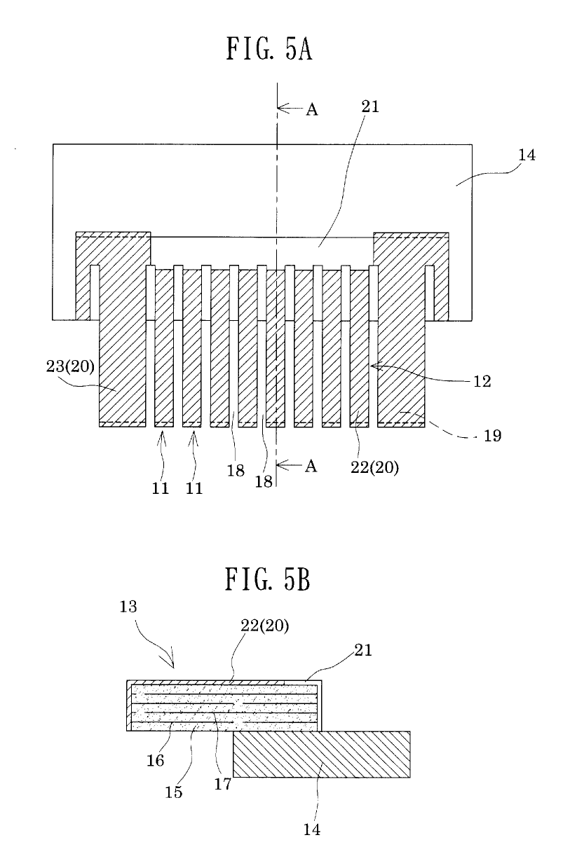

FIG. 4 is a perspective view showing the piezoelectric element unit in an extracted manner. FIGS. 5A and 5B are a plan view of FIG. 4, and a sectional view taken on line A-A in FIG. 5A, respectively. Here, the piezoelectric element unit 10 will be described in further detail with additional reference to FIGS. 4 and 5A, 5B.

As shown in FIGS. 4 and 5A, 5B, the piezoelectric element unit 10 includes a piezoelectric element forming member 13 having a row 12 of a plurality of piezoelectric elements 11 arranged parallel in the width direction thereof, and a fixing plate 14, to which a proximal end portion of the piezoelectric element forming member 13 is joined, such that a leading end portion of the piezoelectric element forming member 13 becomes a free end. The piezoelectric element forming member 13 is formed by piezoelectric material layers 15, and internal electrodes constituting two electrodes of each piezoelectric element 11, namely, an individual internal electrode 16 constituting an individual electrode electrically independent of the adjacent piezoelectric element 11, and a common internal electrode 17 constituting a common electrode electrically common with the adjacent piezoelectric element 11, the piezoelectric material layers 15, the individual internal electrodes 16 and the common internal electrodes 17 being stacked alternately, with the piezoelectric material layer 15 being sandwiched between the individual internal electrode 16 and the common internal electrode 17.

In the piezoelectric element forming member 13, a plurality of slits 18 are formed, for example, by a wire saw, and the leading end portion of the piezoelectric element forming member 13 is cut like the teeth of a comb to form the row 12 of the piezoelectric elements 11. Positioning portions 19 each having a larger width than that of each piezoelectric element 11 are provided outwardly of and on both sides of the row 12 of the piezoelectric elements 11. These positioning portions 19 are intended for positioning the piezoelectric element unit 10 with high accuracy when integrating the piezoelectric element unit 10 into the ink-jet recording head.

The individual internal electrode 16 to serve as the individual electrode of each piezoelectric element 11 is basically provided over nearly the entire surface of the piezoelectric element forming member 13, but is separated into a leading end side and a proximal end side in a region opposing a site close to the end surface of the fixing plate 14. On the other hand, the common internal electrode 17 to serve as the common electrode is basically provided over nearly the entire surface of the piezoelectric element forming member 13, but similarly to the individual internal electrode 16, is separated near the leading end portion of the piezoelectric element 11. That is, a region of the piezoelectric element 11 joined to the fixing plate 14 is an inert region which does not contribute to vibration. When a voltage is applied between the individual internal electrode 16 and the common internal electrode 17 constituting the piezoelectric element 11, only a region beside the leading end of the piezoelectric element 11, which is not joined to the fixing plate 14, vibrates.

An external electrode 20 connected to the individual internal electrode 16 and the common internal electrode 17 is formed on the outer surface of the piezoelectric element forming member 13. A non-electrode-forming portion 21, where the external electrode 20 does not exist, is present at least on the proximal end side of the region of the piezoelectric element forming member 13 corresponding to the row 12 of the piezoelectric elements 11.

The plurality of slits 18 are formed with a length reaching the region opposing the non-electrode-forming portion 21. The external electrode 20 is separated by the slits 18 and the non-electrode-forming portion 21 to constitute individual external electrodes 22 electrically independent of the adjacent piezoelectric element 11, and common external electrodes 23 electrically common with the adjacent piezoelectric element.

Concretely, the external electrode 20 is separated into a portion opposing each piezoelectric element 11, and a portion opposing each positioning portion 19. The external electrode 20 in a region opposed to each piezoelectric element 11 constitutes the individual external electrode 22 which is electrically connected to the individual internal electrode 16 constituting the individual electrode of the piezoelectric element 11 in the leading end portion of the piezoelectric element forming member 13. On the other hand, the external electrodes 20 on the positioning portions 19 provided on both sides of the row 12 of the piezoelectric elements 11 constitute the common external electrodes 23 which are connected to the common internal electrode 17 constituting the common electrode of each piezoelectric element 11 at the end surface on the proximal end side of the piezoelectric element forming member 13.

That is, in the piezoelectric element unit 10, the individual external electrodes 22 are arranged parallel on the surface of the piezoelectric element forming member 13 on the side opposite to the portion of the piezoelectric element forming member 13 joined to the fixing plate 14, and the common external electrodes 23 are existent in the regions on both sides, in the parallel arrangement direction, of the individual external electrodes 22 and opposed to the positioning portions 19. Because of this configuration, the piezoelectric element unit 10 and a wiring plate (to be described later) can be connected together relatively easily, and the piezoelectric element unit 10 can be downsized.

In the piezoelectric element unit 10 mentioned above, a surface of the fixing plate 14 on the side opposite to its surface fixed to the piezoelectric element forming member 13 is fixed to the accommodating portion 58a of the head case 58, as shown in FIGS. 1A and 1B. A wiring plate 30 of a film form, which supplies a signal for driving each piezoelectric element 11, is connected to the piezoelectric element unit 10.

The wiring plate 30 has connection wiring 33 connected to the individual external electrode 22 and the common external electrode 23 of the piezoelectric element 11. A drive IC 31, which supplies a drive signal for driving each piezoelectric element 11, is mounted on the wiring plate 30. A tape carrier package (TCP), such as a TAB tape, can be preferably used as the wiring plate 30. That is, the wiring plate 30 can be constituted by forming a conductive layer of a predetermined pattern on the surface of a base film 32 of polyimide or the like with the use of a copper foil or the like, plating the conductive layer to form the connection wiring 33, and then covering the connection wiring 33 with an insulation film 34 of a resist or the like, except for regions of the connection wiring 33, which are connected to the piezoelectric elements 11 and a terminal portion (to be described later), and a region of the connection wiring 33 which is connected to the terminal of the drive IC 31. The drive IC 31 is mounted on the wiring plate 30, and then covered with the insulation film 34 for covering the connection wiring 33.

Such wiring plate 30 is disposed such that the drive IC 31 is located on its surface opposing the fixing plate 14, and the drive IC 31 is located in a central region, in the width direction, of the wiring plate 30. One end portion of the connection wiring 33 is electrically connected to the individual external electrode 22 and the common external electrode 23 which are located on the end side of the piezoelectric element 11 fixed to the fixing plate 14. The electrical connection is made via a metal layer 35 formed, for example, by forming a metal, such as a tin (Sn)-bismuth (Bi) alloy, on the surface of the connection wiring 33 and the surfaces of the individual external electrode 22 and the common external electrode 23, and heating the metal, with the connection wiring 33 and the individual external electrode 22/common external electrode 23 in contact.

Other end portion of the connection wiring 33 of the wiring plate 30 on the side opposite to the one end portion thereof connected to the piezoelectric element 11 is bent and connected to a terminal portion 61a of input wiring 61 of an input wiring plate 60 provided on a surface of the head case 58 on the side opposite to its surface where the vibration plate 55 is provided.

The input wiring plate 60 provided on the head case 58 is intended for supplying a drive voltage, a print signal, etc. to the drive IC 31 and the piezoelectric element 11 from the outside. Such input wiring plate 60 is provided on the surface of the head case 58 on the side opposite to its surface where the vibration plate 55 is provided. Thus, the wiring plate 30 connected to the piezoelectric elements 11 fixed in the accommodating portion 58a is bent by an angle of about 90 degrees at its portion connected to the terminal portion 61a of the input wiring 61 of the input wiring plate 60, and an end portion of the connection wiring 33 is connected to the terminal portion 61a. The connection wiring 33 and the terminal portion 61a are electrically connected via a metal layer 36 formed, for example, by forming a metal, such as a tin-phosphor copper alloy, on the surface of the terminal portion 61a of the input wiring 61, and then heating the metal, with the connection wiring 33 and the terminal portion 61a in contact. Moreover, the wiring plate 30 is adhesive-bonded to the fixing plate 14 via ultraviolet curing adhesive agents (UV adhesives) 40, 41, 42.

With the above-described ink-jet recording head, ink is supplied to the reservoir 53 through the ink supply path communicating with an ink cartridge, and is distributed to each pressure generating chamber 52 via the ink supply path 54. On this occasion, voltage is applied to the piezoelectric element 11 to contract the piezoelectric element 11. As a result, the vibration plate 55 is raised together with the piezoelectric element 11 to increase the volume of the pressure generating chamber 52 to draw the ink into the pressure generating chamber 52. After the interior of the pressure generating chamber 52 is filled with the ink up to the nozzle orifice 56, the voltage applied to the piezoelectric element 11 is released in accordance with a recording signal from the drive IC 31. Consequently, the piezoelectric element 11 is expanded to return to its original state. Thus, the vibration plate 55 is also displaced, and restored to the original state. Hence, the pressure generating chamber 52 is contracted, and increased in internal pressure, whereby an ink droplet is ejected through the nozzle orifice 56.

The present embodiment is configured such that the inertances M₁ and M₂ and the passage resistances R₁ and R₂ of the ink supply path 54 and the nozzle orifice 56, which govern the ejection characteristics of the ink in the above situation, satisfy the aforementioned predetermined relationships. Thus, even when ink of a high viscosity is used, satisfactory ejection characteristics can be obtained.

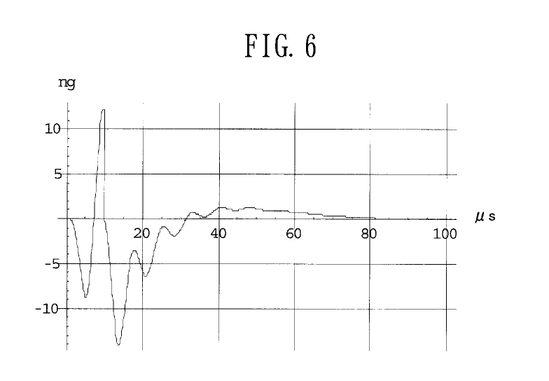

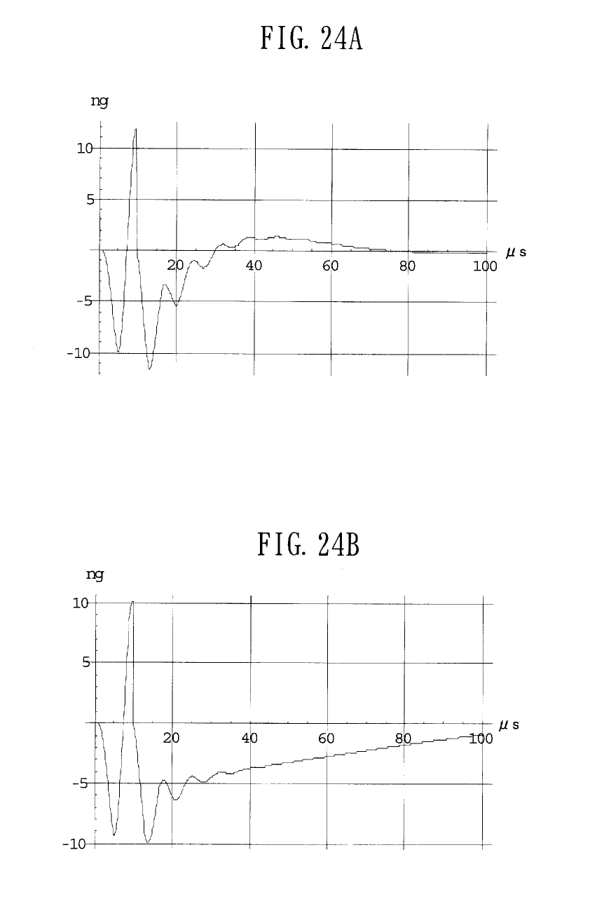

FIG. 6 is a characteristic chart obtained when ink having a high viscosity (a viscosity of 10.0 (mPa·s)) was ejected using the ink-jet recording head according to the present embodiment, and the behavior of meniscus at this time was simulated, a chart corresponding to FIG. 24B. In this drawing, the abscissa represents time (μs), and the ordinate represents the weight of the ink ejected (ng).

Other parameters of the ink-jet recording head were as follows:

Diameter of nozzle orifice 56=24 μm. Inertance M₁ of ink supply path 54=1.9×10⁸ (kg/m⁴). Inertance M₂ of nozzle orifice 56=1.4×10⁸ (kg/m⁴). Passage resistance R₁ of ink supply path 54=0.69×10¹³ (Pa·s/m³). Passage resistance R₂ of nozzle orifice 56=4.3×10¹³ (Pa·s/m³).

As noted above, the following relationships hold: M₂ (=1.4×10⁸ (kg/m⁴))<M₁ (=1.9×10⁸ (kg/m⁴)) and R₂ (=4.3×10¹³ (Pa·s/m³))>2×R₁ (=2×0.69×10¹³ (Pa·s/m³). At the same time, the relationship 3×R₁≦R₂≦20×R₁ also holds.

Reference to FIG. 6 shows that even when the viscosity of the ink was 10.0 (mPa·s), 12 (ng) of an ink droplet was ejected, and return after ejection was sufficiently fast.

### Other Embodiment of Liquid-Jet Head

The liquid-jet head according to the present embodiment is the same ink-jet recording head as in the above embodiment shown in FIGS. 1A and 1B, but is different in the specifications. The ink-jet recording head according to the present embodiment has the following specifications: Diameter of nozzle orifice 56=25 μm. Inertance M₁ of ink supply path 54=2.0×10⁸ (kg/m⁴). Inertance M₂ of nozzle orifice 56=1.5×10⁸ (kg/m⁴). Passage resistance R₁ of ink supply path 54=1.5×10¹³ (Pa·s/m³). Passage resistance R₂ of nozzle orifice 56=6.8×10¹³ (Pa·s/m³). As noted here, the following relationships hold: M₂ (=1.5×10⁸ (kg/m⁴))<M₁ (=2.0×10⁸ (kg/m⁴)) and R₂ (=6.8×10¹³ (Pa·s/m³))>2R₁ (=2×1.5×10¹³ (Pa·s/m³). At the same time, the relationship 3×R₁≦R₂≦20×R₁ also holds. With the ink-jet recording head according to the present embodiment, (R₂/R₁)≈5.

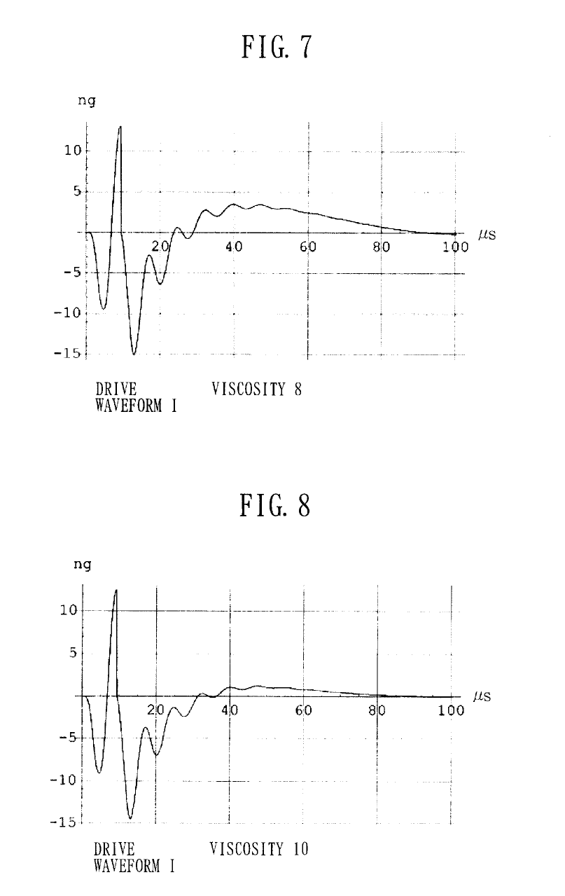

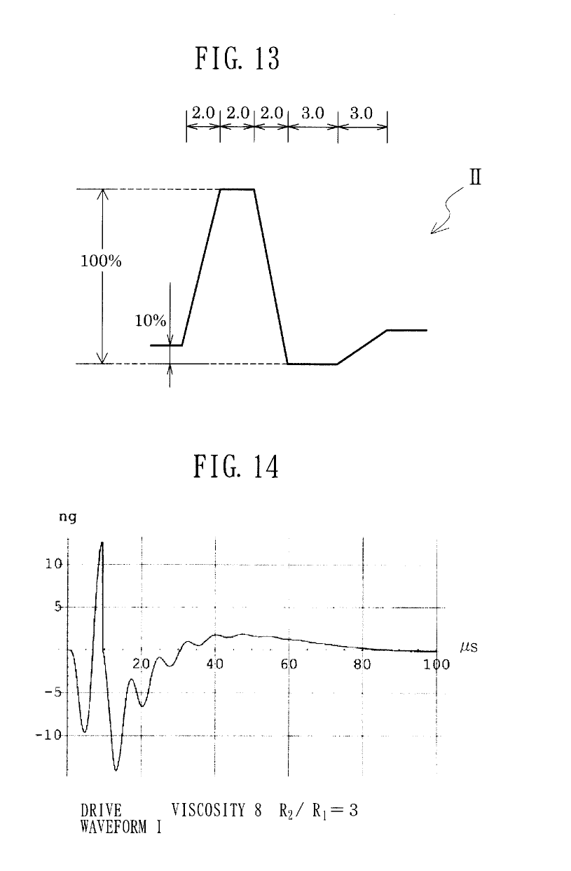

FIGS. 7 to 11 are characteristic charts similar to FIG. 6, showing the ejection characteristics of the ink exhibited when the viscosity and/or drive waveform of the ink were or was changed in the ink-jet recording head according to the present embodiment. Here, two waveforms, i.e. that shown in FIG. 12 and that shown in FIG. 13, were used. The waveform I shown in FIG. 12 is such that predetermined voltages are applied in predetermined periods of time (2.0 μs, 2.5 μs, 2.5 μs, 3.0 μs and 3.0 μs in this sequence) to the piezoelectric element 11 (see FIGS. 1A, 1B) to which a voltage being 30% of maximum voltage is applied as an initial value. The waveform II shown in FIG. 13 is such that predetermined voltages are applied in predetermined periods of time (2.0 μs, 2.0 μs, 2.0 μs, 3.0 μs and 3.0 μs in this sequence) to the piezoelectric element 11 (see FIGS. 1A, 1B) to which a voltage being 10% of maximum voltage is applied as an initial value. Here, for the drive waveform II, the difference between the initial value and the maximum voltage is greater than the difference for the drive waveform I. Thus, in correspondence with this greater difference, the piezoelectric element 11 can be distorted more greatly to expand the pressure generating chamber 52 (see FIGS. 1A, 1B) to a greater extent. Consequently, the application of the drive waveform II results in the smooth supply of the ink.

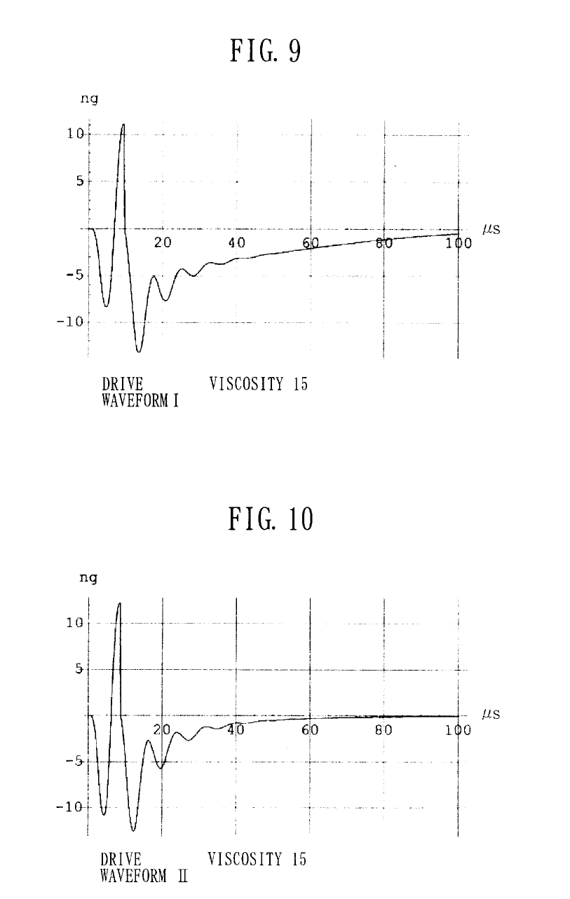

FIGS. 7 to 9 are the characteristic charts obtained when the drive waveform I was applied, and inks having viscosities of 8.0 (mPa·s), 10.0 (mPa·s) and 15.0 (mPa·s) were used. The characteristics in FIG. 7 are those for the ink having a viscosity of 8.0 (mPa·s), and show that 13 (ng) of an ink droplet was ejected, and return characteristics were not problematical for practical use, although a slight rise occurred after ejection. The characteristics in FIG. 8 are those for the ink having a viscosity of 10.0 (mPa·s), and show that 12 (ng) of an ink droplet was ejected, and return after ejection was sufficiently fast. That is, the amount of ejection and the return characteristics in this case are very satisfactory. The characteristics in FIG. 9 are those for the ink having a viscosity of 15.0 (mPa·s), and show that 11 (ng) of an ink droplet was ejected, and return after ejection was slightly delayed.

FIG. 10 is the characteristic chart obtained when ink having a viscosity of 15.0 (mPa·s) was used, but the drive waveform II was applied. In this case, 12 (ng) of an ink droplet was ejected, and return after ejection was sufficiently faster than in FIG. 9.

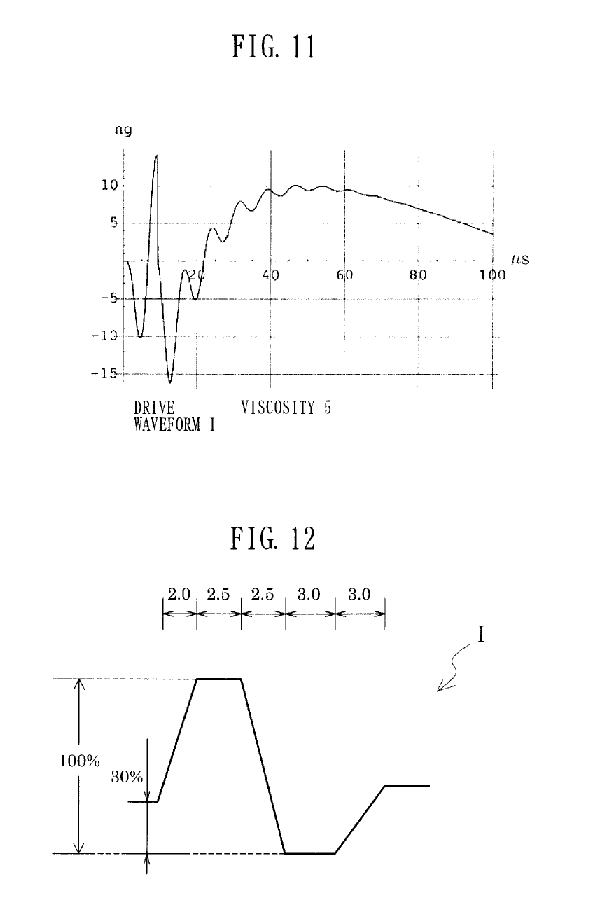

FIG. 11 is the characteristic chart obtained when ink having a viscosity of 5.0 (mPa·s) was used, and the drive waveform I was applied for driving, in the present embodiment. In this case, rise after ejection was so great (namely, meniscus rose above the nozzle surface) that ejection became unstable.

FIG. 14 is a characteristic chart obtained when the parameter (passage resistance R₂ of nozzle orifice 56)/(passage resistance R₁ of ink supply path 54)=3 was set, ink having a viscosity of 8.0 (mPa·s) was used, and the drive waveform I was applied for driving, in the present embodiment. This chart shows that in comparison with the case of FIG. 7 in which ink having the same viscosity (8.0 (mPa·s)) was used, rise after ink ejection was successfully suppressed by fulfilling the requirement R₂>2R₁ and then appropriately selecting a value for the ratio R₂/R₁.

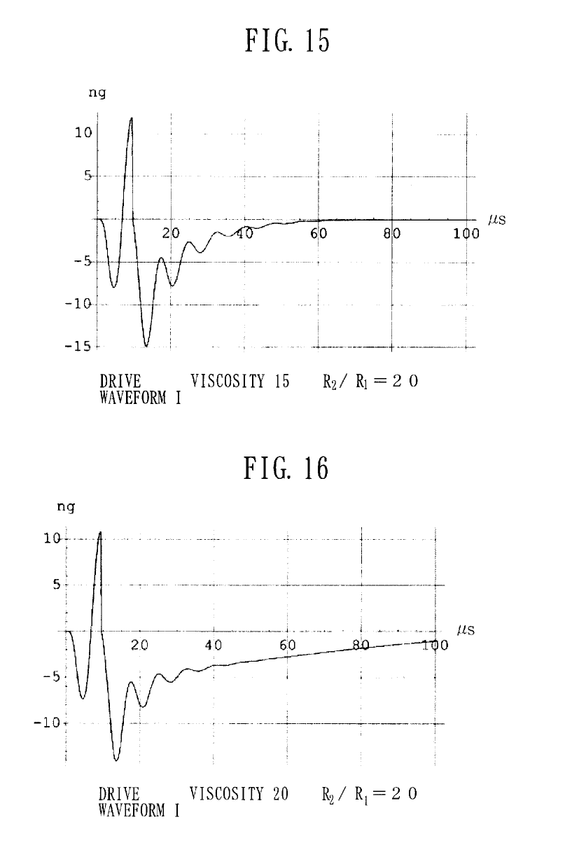

FIGS. 15 and 16 are characteristic charts obtained when the ratio (passage resistance R₂ of nozzle orifice 56)/(passage resistance R₁ of ink supply path 54)=20 was set, ink having a viscosity of 15.0 (mPa·s) (FIG. 15) or 20.0 (mPa·s) (FIG. 16) was used, and the drive waveform I was applied for driving, in the present embodiment. In these cases, the requirements R₂>2R₁ and 3×R₁≦R₂≦20×R₁ were fulfilled. Reference to FIG. 15 shows that in comparison with the characteristics shown in FIG. 9 in which the conditions other than R₂/R₁ were the same as in FIG. 15, the delay in the return characteristics was markedly curtailed. That is, the higher the viscosity of ink, the higher ratio R₂/R₁ is desirable.

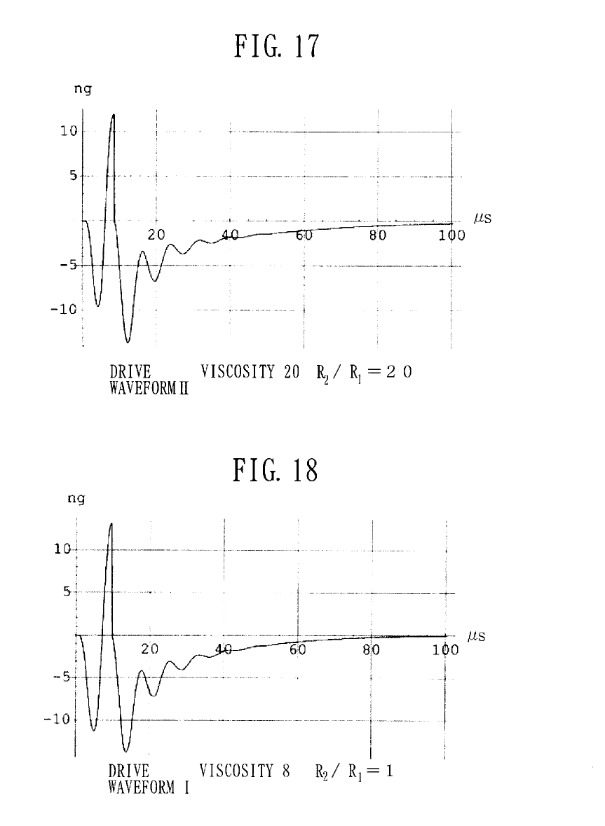

FIG. 17 is a characteristic chart obtained when the ratio R₂/R₁ was set at 20, ink having a viscosity of 20.0 (mPa·s) was used, and the drive waveform II was applied for driving. This chart shows that in comparison with the case of FIG. 16 where only the drive waveform was different (drive waveform I), rise characteristics after ejection were markedly improved by driving the recording head with the drive waveform II having a low initial value of drive voltage. That is, as the viscosity of ink increases, it is desirable for the drive waveform II to be applied for driving.

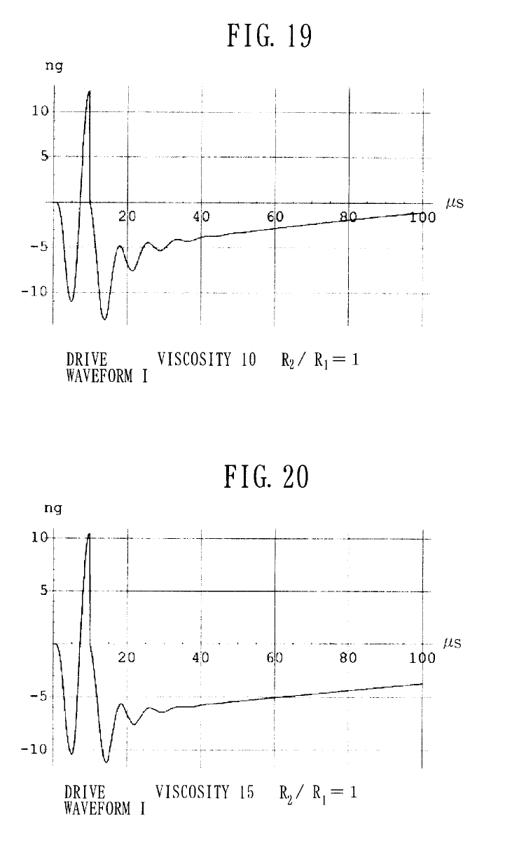

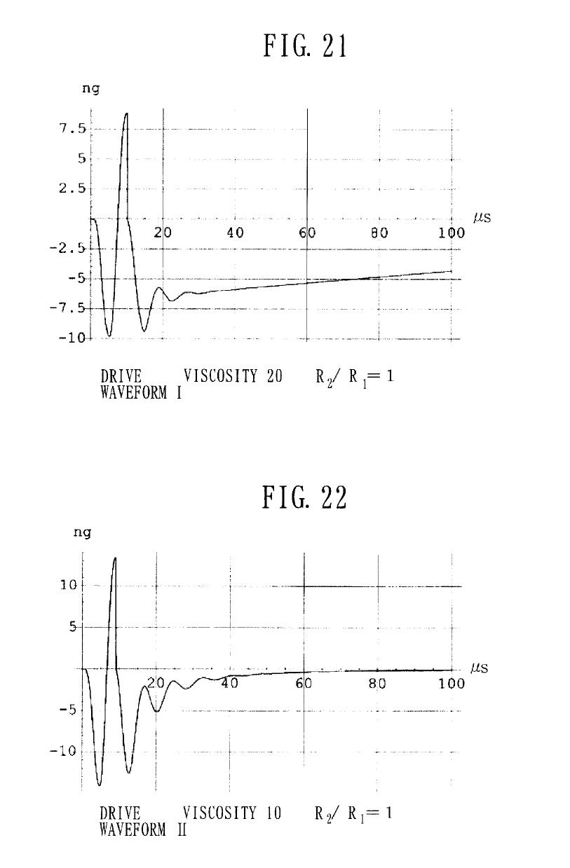

FIGS. 18 to 21 show the ejection characteristics of an ink-jet recording head having the structure of the related art with R₂/R₁=1 for comparison with the ejection characteristics of the ink-jet recording head according to the present embodiment. These characteristic charts were obtained when the drive waveform I was applied, and inks having viscosities of 8.0 (mPa·s), 10.0 (mPa·s), 15.0 (mPa·s) and 20.0 (mPa·s) were used. Reference to these drawings shows that with the exception of the case where the viscosity was 8.0 (mPa·s), return after ejection was slow when the ink having a higher viscosity was used, and that this tendency became more marked with higher ink viscosities. However, even when ink having a viscosity of 10.0 (mPa·s) was used in the ink-jet recording head with R₂/R₁=1, the application of the drive waveform II produced an improvement in the return characteristics to a practically unproblematic extent, as shown in FIG. 22. If the viscosity is 15 (mPa·s) or higher, however, the return characteristics unproblematic for practical use are not obtained.

The foregoing results of simulations show that according to the present embodiment, even when ink having a high viscosity is used, adjustments can be easily made such that satisfactory return characteristics are reliably obtained. Thus, even if the viscosity of ink is increased or decreased according to the ambient temperature during use, stable ejection characteristics can be obtained. With the structure of the related art (R₂/R₁=1), on the other hand, even at a viscosity of the order of 8.0, sufficient return characteristics may be obtained, depending on other conditions. However, if consideration is given to factors changing the viscosity, such as temperature changes in the service environment, the range of temperature changes which can be followed is narrowed, and the ejection characteristics become unstable accordingly. After all, when ink having a higher viscosity than in the related art is used, the ink-jet recording head according to the present embodiment can provide more stable ejection characteristics, which can contribute to speedy printing reliably.

### Other Embodiments of Liquid-Jet Head

The invention has been described in connection with the above embodiments, but needless to say, the invention is not limited thereto. For example, the ink-jet recording head according to these embodiments is a head having a longitudinal vibration actuator in which piezoelectric materials and electrode-forming materials are alternately stacked, and the resulting laminate is expanded and contracted in the axial direction. However, the invention can be likewise applied to a head having a piezoelectric element, which is a thin film actuator, as a pressure generator for causing a pressure change to a pressure generating chamber; or to a head having as the pressure generator a piezoelectric element which is a thick film actuator formed by a method such as pasting a green sheet. Furthermore, the invention can be applied to a so-called bubble actuator in which a heating element is disposed as the pressure generator within the pressure generating chamber, and a liquid droplet is ejected through the nozzle orifice by a bubble produced by heat generation of the heating element; or to a so-called electrostatic actuator in which static electricity is produced between the vibration plate and the electrode, and the vibration plate is deformed by an electrostatic force to eject a liquid droplet through the nozzle orifice. In short, the invention may be applied to any device in which a liquid is supplied from the liquid supply path to the pressure generating chamber, and the liquid is ejected through the nozzle orifice under pressure generated in the pressure generating chamber. In this case, the device of any type can obtain liquid ejection characteristics comparable to those of the head shown in FIGS. 1A, 1B.

Besides, the invention widely targets liquid-jet heads in general and, needless to say, can be applied to liquid-jet heads for jetting liquids other than ink. Other liquid-jet heads include, for example, various recording heads for use in image recording devices such as printers, coloring material jet heads for use in the production of color filters such as liquid crystal displays, electrode material jet heads for use in the formation of electrodes for organic EL displays and FED (field emission displays), and bio-organic material jet heads for use in the production of biochips.

### Liquid-Jet Recording Apparatus Having the Liquid-Jet Head According to any of the Above Embodiments

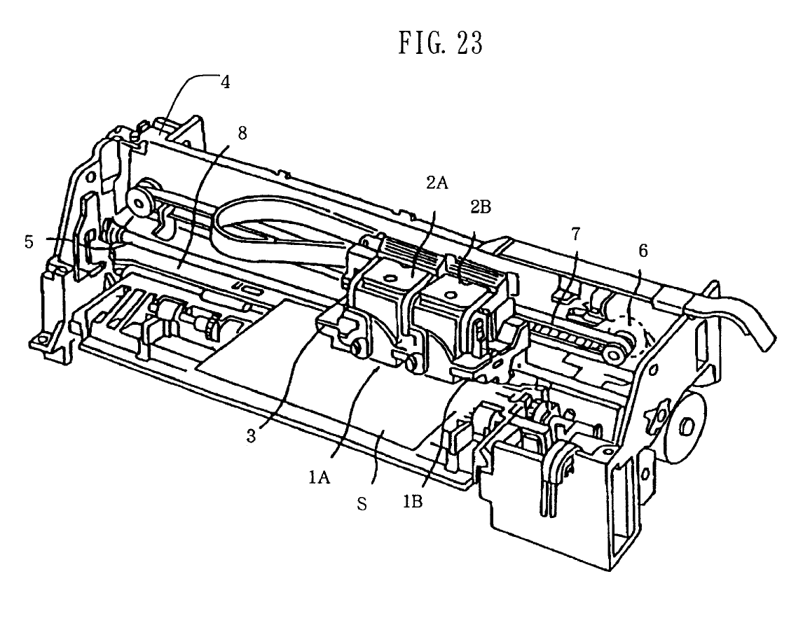

The ink-jet recording head of each of the above embodiments is mounted on an ink-jet recording apparatus as a part of a recording head unit having ink passages communicating with an ink cartridge, etc. FIG. 23 is a schematic view showing an example of this ink-jet recording apparatus. As shown in this drawing, cartridges 2A and 2B constituting ink supply units are detachably provided in recording head units 1A and 1B having the ink-jet recording heads according to any of the embodiments, and a carriage 3 bearing the recording head units 1A and 1B is provided axially movably on a carriage shaft 5 mounted on an apparatus body 4. The recording head units 1A and 1B are to eject, for example, a black ink composition and a color ink composition, respectively.

The drive force of a drive motor 6 is transmitted to the carriage 3 via a plurality of gears (not shown) and a timing belt 7, whereby the carriage 3 bearing the recording head units 1A and 1B is moved along the carriage shaft 5. The apparatus body 4 is provided with a platen 8 along the carriage shaft 5, and a recording sheet S as a recording medium, such as paper, which has been fed by a sheet feed roller or the like (not shown), is transported on the platen 8. It should be understood that changes, substitutions and alterations can be made in the invention without departing from the spirit and scope of the invention as defined by the appended claims.

What is claimed is:

1. A liquid-jet head comprising a pressure generating chamber, which is supplied with a liquid via a liquid supply path and in which a nozzle orifice for jetting the liquid is formed, and a pressure generator for causing a pressure change within the pressure generating chamber,
wherein when the liquid has a viscosity of 8 (mPa·s) or higher and an inertance and a passage resistance of the liquid supply path are designated as M₁ and R₁, respectively, and an inertance and a passage resistance of the nozzle orifice are designated as M₂ and R₂, respectively, relationships M₂<M₁ and R₂>2R₁ hold,
wherein the passage resistances R₁ and R₂ are determined based on the viscosity of the liquid.

2. The liquid-jet head according to claim 1, wherein the liquid has a viscosity of 8.0 (mPa·s) or higher, but 20.0 (mPa·s) or lower.

3. The liquid-jet head according to claim 1, wherein a relationship between the passage resistances R₁ and R₂ is 3R₁≦R₂≦20R₁.

4. The liquid-jet head according to claim 1 wherein when a cross-sectional area of the liquid supply path is designated as S₁, and a cross-sectional area of a liquid ejection port of the nozzle orifice is designated as S₂, a relationship S₂<S₁ holds.

5. A liquid-jet apparatus including the liquid-jet head according to claim 1.

6. A liquid-jet head, comprising:
a pressure generating chamber, which is supplied with a liquid via a liquid supply path;
a nozzle for jetting the liquid out of said pressure generating chamber; and
a pressure generator for causing a pressure change within the pressure generating chamber to cause the jetting of the liquid,
wherein when the liquid has a viscosity of 8 (mPa·s) or higher, a ratio of an inertance of the liquid supply path to an inertance of the nozzle satisfy the relationship of M₂<M₁ and a ratio of a passage resistance of the liquid supply path to the nozzle satisfy the relationship R₂>2R₁,
wherein the inertance of the liquid supply path and nozzle are designated as M₁ and M₂, respectively, and wherein the passage resistance of the liquid supply path and the nozzle orifice are designated as R₁ and R₂, respectively, and
wherein the passage resistances R₁ and R₂ are determined based on the viscosity of the liquid.
